(19) United States
(12) Patent Application Publication
(10) Pub. No.: US 2006/0116236 A1
(43) Pub. Date: Jun. 1, 2006

(54) Torque converter clutch release to prevent engine stall

(76) Inventors: Christopher J. Trush, Novi, MI (US); Aaron C. Heckel, South Lyon, MI (US); Daniel J. Wickman, Plymouth, MI (US)

Correspondence Address: Christopher DeVries;General Motors Corporation,, Legal Staff, Mail Code: 483-C23-B21, 300 GM Renaissance Center, Detroit, MI, 48265-3000, US

(21) Appl. No.: 11/001,694

(22) Filed: Dec. 1, 2004

(51) Int. Cl. F16H 61/58

(52) U.S. Cl. 477/62

(57) ABSTRACT

A torque converter control system for a vehicle includes a torque converter having a torque converter clutch (TCC) that selectively couples an engine and a transmission for common rotation. A control module regulates the TCC between an engaged state and a disengaged state. The control module monitors an output shaft signal of the transmission and detects rapid deceleration of the vehicle based on the output shaft signal. The control module switches the TCC to the disengaged state when rapid deceleration is detected.

### FIELD OF THE INVENTION

The present invention relates to vehicles including a torque converter clutch (TCC), and more particularly to TCC release systems that prevent engine stall.

### BACKGROUND OF THE INVENTION

Traditional vehicle systems include an engine that drives a transmission through a coupling device such as a torque converter. The torque converter provides a fluid coupling that enables the engine to rotate somewhat independently of the transmission. Some torque converters include a torque converter clutch (TCC) that selectively couples the engine and transmission for direct drive. More specifically, when in the engaged or locked state, there is no relative slip between the engine crankshaft and the transmission input shaft.

In some instances a vehicle driver may be required to brake the vehicle very rapidly. In cases where the TCC is locked, rapid deceleration can result in engine stall. More specifically, the engine can be caused to stall because it is coupled to the transmission, which is inhibited from rotating as a result of the rapid brake maneuver.

To inhibit occurrences of engine stall during rapid brake maneuvers, traditional vehicle systems include a brake switch that detects a brake pedal position. The brake switch is provided as an ON/OFF switch that indicates when the brake pedal is being depressed. However, in the event that the brake switch fails during a driving cycle, the failure cannot be detected until a subsequent driving cycle (i.e., vehicle is turned OFF than turned back ON again). Further, in the event of a brake switch failure during a drive cycle, the vehicle control system cannot differentiate between a faulty brake switch or the driver depressing the brake pedal.

### SUMMARY OF THE INVENTION

Accordingly, the present invention provides a torque converter control system for a vehicle. The torque converter control system includes a torque converter having a torque converter clutch (TCC) that selectively couples an engine and a transmission for common rotation. A control module regulates the TCC between an engaged state and a disengaged state. The control module monitors an output shaft signal of the transmission and detects rapid deceleration of the vehicle based on the output shaft signal. The control module switches the TCC to the disengaged state when rapid deceleration is detected.

In another feature, the torque converter control system further includes an output shaft speed sensor that generates the output shaft signal indicative of a rotational velocity of an output shaft of the transmission.

In another feature, rapid deceleration is detected when a rate of change of the output shaft signal exceeds a threshold rate of change.

In other features, the torque converter control system further includes a solenoid that regulates a pressurized fluid flow to the TCC. The control module adjusts a setting of the solenoid to inhibit pressurized fluid flow to the TCC when in the disengaged state. The solenoid is a pulse-width modulated (PWM) solenoid. Alternatively, the solenoid can be a variable bleed solenoid (VBS).

In yet another feature, the torque converter control system further includes a solenoid that regulates a pressurized fluid flow to the TCC and an enable valve that selectively inhibits the pressurized fluid flow to the TCC. The control module adjusts a setting of the solenoid and turns the enable valve to an OFF state to inhibit pressurized fluid flow to the TCC.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram of a vehicle including a torque converter clutch (TCC) according to the present invention; and

FIG. 2 is a flowchart illustrating steps executed by the TCC release control system of the present invention.

### DETAILED DESCRIPTION OF THE PREFERRED EMBODIMENTS

The following description of the preferred embodiment is merely exemplary in nature and is in no way intended to limit the invention, its application, or uses. For purposes of clarity, the same reference numbers will be used in the drawings to identify similar elements. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

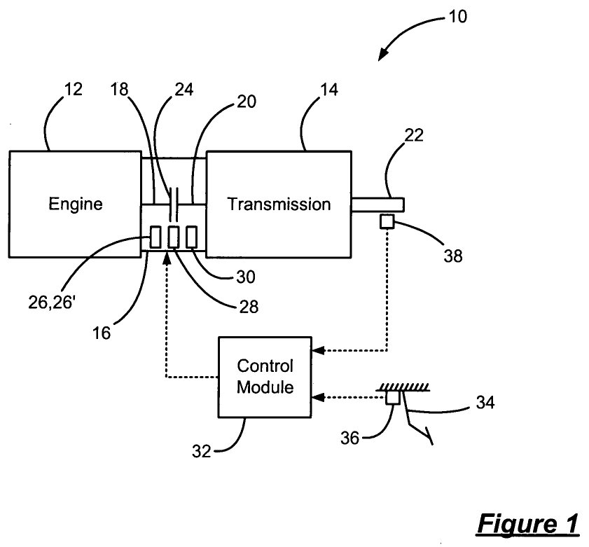

Referring now to FIG. 1, an exemplary vehicle 10 is schematically illustrated. The vehicle 10 includes an engine 12 that drives a transmission 14 through a coupling device 16. More specifically, the engine 12 generates drive torque to drive an engine output shaft or crankshaft 18. The crankshaft 18 is selectively coupled to an input shaft 20 of the transmission 14 through the coupling device 16. The transmission 14 transfers the drive torque to drive an output shaft 22 at a desired gear ratio. The output shaft 22 drives a drivetrain (not shown) to propel the vehicle 10. The transmission 14 is an automatic transmission (ATX) that can include, but is not limited to, a clutch-to-clutch ATX and a freewheel ATX.

The coupling device 16 includes a torque converter with a torque converter clutch (TCC) 24. The torque converter 16 provides a fluid coupling that enables the engine 12 to spin somewhat independently of the transmission 14. If the engine 12 is spinning slowly (e.g., at idle), the amount of drive torque transferred through the torque converter 16 is very small. As the engine speed increases, the amount of drive torque transferred through the torque converter 16 generally increases. Although not illustrated, the torque converter 16 includes a pump, a turbine and a stator. The pump is driven by the engine 12 and pumps hydraulic fluid to drive the turbine. The turbine drives the input shaft 22. The stator redirects the hydraulic fluid from the turbine to the pump. Exemplary torque converters are described in further detail in commonly assigned U.S. Pat. Nos. 6,254,507 and 6,695,111, issued on Jul. 3, 2001 and Feb. 24, 2004, respectively, the disclosures of which are expressly incorporated herein by reference in their entirety.

Initially, the pump and turbine spin at different rotational speeds. Eventually, the pump and turbine rotate at a common rotational speed. The TCC 24 or lock-up clutch selectively locks the pump and turbine for common rotation. More specifically, the TCC 24 is regulated between an engaged state (i.e., coupling the pump and the turbine for common rotation) and a disengaged state (i.e., decoupling the pump and the turbine from common rotation). When in the engaged state, relative rotation or slippage between the pump and turbine is prohibited and the torque converter efficiency is improved.

The torque converter 16 includes various solenoids and or valves that regulate TCC engagement. For example, in the case of a clutch-to-clutch ATX, the torque converter 16 includes a variable bleed solenoid (VBS) 26 that regulates the pressure of hydraulic fluid to the TCC 24. In the case of a freewheel ATX, the torque converter includes a pulse-width modulated (PWM) solenoid 26′, a regulator valve 28 and an enable valve 30. The regulator valve 28 regulates the pressure of the hydraulic fluid to the TCC 24 and the enable valve 30 is an ON/OFF valve that selectively enables the flow of hydraulic fluid to the TCC 24. In one arrangement, the PWM solenoid 26′ controls both the regulator valve 28 and the enable valve 30. In another arrangement, the PWM solenoid 26′ controls the regulator valve 28 only.

A control module 32 regulates overall operation of the vehicle 10 and the torque converter 24. The control module 32 controls the VBS 26, the PWM solenoid 26′, the regulator valve 28 and/or the enable valve 30 to regulate the TCC 24 between the engaged state and the disengaged state. The vehicle 10 further includes a brake pedal 34 and a brake pedal position sensor 36 that generates a brake pedal position signal that is received by the control module 32. The control module 32 regulates vehicle braking based on the brake pedal position signal.

The control module 32 regulates engagement of the TCC 24 based on the TCC release control of the present invention. More specifically, an output shaft sensor 38 is responsive to the rotational velocity of the transmission output shaft 22 and generates a output shaft signal (OSS) based thereon. The OSS is received by the control module 32. The control module 32 calculates an output shaft speed based on the OSS and determines whether a rate of change of the output shaft speed (i.e., output shaft acceleration) is less than a threshold rate of change (i.e., threshold acceleration). In the case of vehicle deceleration, the rate of change of the output shaft speed would be provided as a negative acceleration or deceleration. If the rate of change of the output shaft speed exceeds the threshold rate of change, the vehicle 10 is rapidly decelerating and the control module 32 sets the TCC 24 to the disengaged state. In this manner, the engine 12 is prevented from stalling as a result of the rapid deceleration.

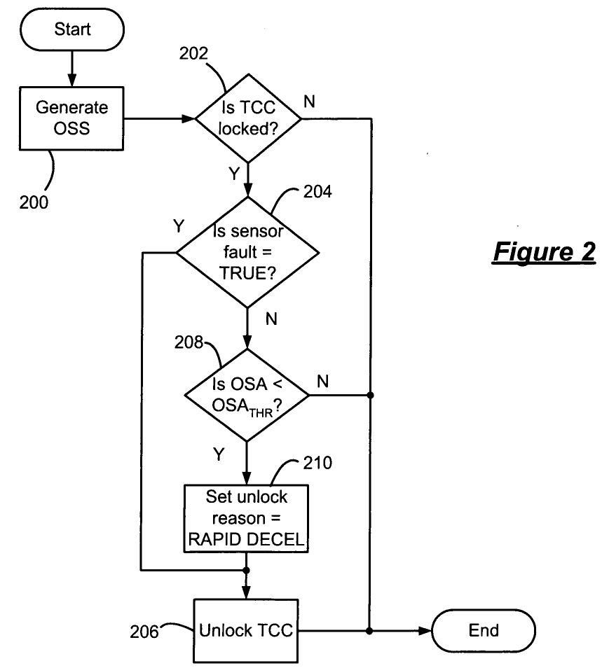

Referring now to FIG. 2, steps executed by the TCC release control system will be described in detail. In step 200, control generates the OSS. In step 202, control determines whether the TCC 24 is locked (i.e., in the engaged state). If the TCC 24 is not locked, control ends. If the TCC 24 is locked, control determines whether there a sensor fault flag is set to TRUE in step 204. If the sensor fault flag is set to TRUE, the output shaft sensor 38 is deemed faulty and control continues in step 206. If the sensor fault flag is not set to TRUE, the output shaft sensor 38 is deemed good and control continues in step 208. In step 208, control determines whether the output shaft acceleration (OSA) is less than an output shaft acceleration threshold (OSA_{THR}). If the OSA is not less than the OSA_{THR}, control ends. If the OSA is less than the OSA_{THR}, control sets the unlock reason to rapid deceleration in step 210. In step 206, control unlocks the TCC 24 and control ends.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A torque converter control system for a vehicle, comprising:
a torque converter including a torque converter clutch (TCC) that selectively couples an engine and a transmission for common rotation; and
a control module that regulates said TCC between an engaged state and a disengaged state, that monitors an output shaft signal of said transmission, that detects rapid deceleration of said vehicle based on said output shaft signal and that switches said TCC to said disengaged state when rapid deceleration is detected.

2. The torque converter control system of claim 1 further comprising an output shaft speed sensor that generates said output shaft signal indicative of a rotational velocity of an output shaft of said transmission.

3. The torque converter control system of claim 1 wherein rapid deceleration is detected when a rate of change of said output shaft signal exceeds a threshold rate of change.

4. The torque converter control system of claim 1 further comprising a solenoid that regulates a pressurized fluid flow to said TCC, wherein said control module adjusts a setting of a solenoid to inhibit pressurized fluid flow to said TCC when in said disengaged state.

5. The torque converter control system of claim 4 wherein said solenoid is a pulse-width modulated (PWM) solenoid.

6. The torque converter control system of claim 4 wherein said solenoid is a variable bleed solenoid (VBS).

7. The torque converter control system of claim 1 further comprising:
a solenoid that regulates a pressurized fluid flow to said TCC; and
an enable valve that selectively inhibits said pressurized fluid flow to said TCC, wherein said control module adjusts a setting of said solenoid and turns said enable valve to an OFF state to inhibit pressurized fluid flow to said TCC.

8. A method of regulating a torque converter clutch (TCC) in a vehicle from an engaged state to a disengaged state, comprising:
monitoring an output shaft signal of a transmission;
detecting rapid deceleration of said vehicle based on said output shaft signal; and
switching said TCC to a disengaged state when rapid deceleration is detected.

9. The method of claim 8 wherein said output shaft signal indicates a rotational velocity of an output shaft of said transmission.

10. The method of claim 8 wherein rapid deceleration is detected when a rate of change of said output shaft signal exceeds a threshold rate of change.

11. The method of claim 8 wherein said step of switching said TCC to a disengaged state includes adjusting a setting of a solenoid to inhibit pressurized fluid flow to said TCC.

12. The method of claim 11 wherein said solenoid is a pulse-width modulated (PWM) solenoid.

13. The method of claim 11 wherein said solenoid is a variable bleed solenoid (VBS).

14. The method of claim 8 wherein said step of switching said TCC to a disengaged state includes:
adjusting a setting of a solenoid to inhibit pressurized fluid flow to said TCC; and
turning an enable valve to an OFF state.

15. A method of inhibiting engine stall in a vehicle, comprising:
monitoring an output shaft of a transmission;
calculating an output shaft acceleration;
detecting rapid deceleration of said vehicle based on said output shaft acceleration; and
switching said TCC to a disengaged state when rapid deceleration is detected.

16. The method of claim 15 further comprising generating an output shaft signal based on a rotational velocity of said output shaft.

17. The method of claim 16 wherein rapid deceleration is detected when said output shaft acceleration exceeds a threshold acceleration.

18. The method of claim 15 wherein said step of switching said TCC to a disengaged state includes adjusting a setting of a solenoid to inhibit pressurized fluid flow to said TCC.

19. The method of claim 18 wherein said solenoid is a pulse-width modulated (PWM) solenoid.

20. The method of claim 18 wherein said solenoid is a variable bleed solenoid (VBS).

21. The method of claim 15 wherein said step of switching said TCC to a disengaged state includes:
adjusting a setting of a solenoid to inhibit pressurized fluid flow to said TCC; and
turning an enable valve to an OFF state.
